(19) United States
(12) Patent Application Publication
(10) Pub. No.: US 2017/0066678 A1
(43) Pub. Date: Mar. 9, 2017

(54) Tempering and Cooling System for a Tempered Glass

(71) Applicant: LUOYANG LANDGLASS TECHNOLOGY CO., LTD., Luoyang City, Henan Province (CN)

(72) Inventors: Yan ZHAO, Luoyang (CN); Chunwei JIANG, Luoyang (CN); Maidun SHAO, Luoyang (CN)

(73) Assignee: LUOYANG LANDGLASS TECHNOLOGY CO., LTD., Luoyang City, Henan Province (JP)

(21) Appl. No.: 15/122,738

(22) PCT Filed: May 14, 2015
(86) PCT No.: PCT/CN2015/078935

§ 371 Date: Aug. 31, 2016

(30) Foreign Application Priority Data
May 15, 2014 (CN) 201410205432.6

(51) Int. Cl. C03B 27/04

(52) U.S. Cl. CPC C03B 27/0417

(57) ABSTRACT

This application discloses a tempering and cooling system for a glass plate. The system comprises a roller table to convey the glass plate, wind gratings to blow air to reduce a surface temperature of the glass plate, and a temperature sensor arranged above and/or below the roller table to detect the surface temperature and enable the system to control a tempering process and/or a cooling process of the glass plate according to the detected surface temperature. The system controls the wind gratings to: produce a first wind pressure when the glass plate is in a tempering stage; produce a second wind pressure when the system determines the detected surface temperature drops to a temperature of a tempering point such that the glass plate enters a cooling stage; produce a third wind pressure when the system determines the detected surface temperature drops to a temperature of a cooling point.

### TECHNICAL FIELD

The present invention relates to a tempering and cooling system of a tempered glass production line, in particular to a system which uses chillers to firstly temper a high-temperature glass plate and then cool the glass plate after tempering.

### BACKGROUND ART

At present, as shown in FIG. 1, a tempered glass production line mainly includes a loading table 1, a heating furnace 2, a quenching and cooling section 3 and an unloading table 4. A glass plate is transferred by roller tables to sequentially pass through the four working positions abovementioned to complete processing, wherein the glass plate is conveyed on the loading table 1; the glass plate after loading enters the heating furnace 2, and the glass plate is heated by the heating furnace 2; the glass plate after heating is sent to the quenching and cooling section 3 to complete tempering and cooling steps, the surface of the glass plate is firstly subjected to air blowing to rapidly reduce the temperature for realizing tempering, and after the temperature of the glass plate drops to the temperature of a tempering point, the glass plate is further cooled to achieve the temperature of a cooling point; and the glass plate after cooling is unloaded on the unloading table 4. In a tempering process, the air pressure is relatively high, the rotational speed of a fan is relatively fast, the energy consumption is high and the noise is also high. After the glass plate enters a cooling process, the air pressure during tempering can be used continuously to facilitate the operation. However, the fan always keeps high rotational speed and high energy consumption, thereby producing relatively great waste of energy, affecting the working condition of the fan and reducing the service life. Or, after the glass plate enters the cooling process, the relatively low air pressure is adopted and the rotational speed of the fan is reduced. Although the method is complicated in procedure, the energy consumption can be reduced, and the working condition of the fan can be improved to a certain extent.

The glass plate always takes the time as control reference in the quenching and cooling section 3 regardless of the tempering process or the cooling process, namely the time for completing tempering or cooling of the glass plate is estimated by multiplying the thickness of the glass plate by a time base. The processing method is obtained by summarization according to experience. In order to prevent the problem that the quality of a finished product of the glass plate is affected by insufficient tempering or cooling time, the tempering time or the cooling time is generally prolonged, namely after the glass plate achieves the temperature of the tempering point or the temperature of the cooling point, tempering or cooling is continuously performed. In such a way, although the quality of the finished product of the glass plate can be ensured, the waste of energy is caused; and when the glass plate with a different specification is processed, the tempering time and the cooling time need to be re-estimated, so that the process becomes complex and errors are easy to cause, and the mass production of tempered glass is further adversely affected.

Based on the above reasons, in order to reduce the production energy consumption and improve the quality of the finished product of the glass plate, the applicant improves the tempering and cooling system of the tempered glass production line after long-term test, improvement, research and development.

It should be noted that:

1. The temperature of the tempering point of the glass plate refers to the temperature value which is 50-250° C. lower than the temperature of a strain point of the glass plate (the temperature forming permanent stress of the glass plate).

2. The temperature of the cooling point of the glass plate refers to the temperature value of the glass plate, which is cooled to room temperature (+0-50° C.) after the tempering process.

3. The temperature of the strain point of the glass plate is equivalent to the temperature when the viscosity is 10^{13.6} poises, and the temperature of the strain point of an ordinary flat glass plate is 510-520° C. At the temperature, the glass plate does not produce viscous flow, and the internal stress of the glass plate can be substantially eliminated by performing heat insulation for 4 h.

Invention Contents

Against the problems in the prior art, the present invention provides a tempering and cooling system for tempered glass. The tempering and cooling system breaks the inertial thinking of controlling a glass plate in a tempering stage or a cooling stage by calculating time in an existing mature process. The time of the tempering stage or the cooling stage is controlled by monitoring the temperature of the upper surface and/or the lower surface of the glass plate, after the surface temperature of the glass plate drops to the temperature of a tempering point, the glass plate enters the cooling stage from the tempering stage, and after the temperature of the glass plate drops to the temperature of the cooling point, the cooling is stopped, so that the waste of energy consumption is avoided, the noise is reduced, the process is simplified, the working condition of a fan is improved and the service life of the fan is prolonged.

In order to realize the above purpose, the present invention provides a tempering and cooling system for tempered glass. The tempering and cooling system is arranged on a quenching and cooling section of a tempered glass production line, wherein the quenching and cooling section includes roller tables and chillers, a glass plate is arranged on the roller tables, a temperature sensor for collecting surface temperature of the glass plate is arranged above and/or below the roller tables, and a tempering process and/or a cooling process of the glass plate is controlled according to the surface temperature of the glass plate detected by the temperature sensor; in a tempering stage of the glass plate, when the surface temperature of the glass plate drops to the temperature of a tempering point, the glass plate enters a cooling stage; and in the cooling stage of the glass plate, when the surface temperature of the glass plate drops to the temperature of a cooling point, the cooling is stopped.

Further, one or at least two temperature sensors are equipped above and/or below the roller tables, and the time when the tempering stage is ended and the time when the cooling stage of the glass plate is ended are determined according to the maximum value of the temperature detected by all the temperature sensors every time.

Further, the temperature sensor is a oscillating-type temperature sensor, and the temperature sensor is used for scanning the surface of the glass plate by oscillating during working to collect the surface temperature of the glass plate in a glass plate region covered by a scanning range.

Further, the temperature sensor can be mounted in the quenching and cooling section in a way of performing reciprocating movement parallel to the surface of the glass plate and is used for scanning the surface of the glass plate by reciprocating movement during working to collect the surface temperature of the glass plate in a glass plate region covered by a scanning range.

Further, the temperature sensor is mounted on the chillers.

Further, the temperature sensor is an infrared temperature measurement unit.

The present invention has the advantages that, the limited thinking of a traditional process is broken, the surface temperature of the glass plate is collected by using the temperature sensor, and the tempering and the cooling processes are controlled according to the surface temperature of the glass plate, thereby enabling the time used for tempering or cooling of the glass plate to be more precious, not only reducing the energy consumption in the production process of the tempered glass, but also improving the quality of finished tempered glass and facilitating mass production.

### BRIEF DESCRIPTION OF THE DRAWINGS

FIG. 1 is a schematic diagram of an existing tempered glass production line;

FIG. 2 is a schematic diagram of the structure of a tempering and cooling system in the present invention;

FIG. 3 is a schematic diagram of one temperature sensor equipped in the present invention;

FIG. 4 is a schematic diagram of a plurality of temperature sensors equipped in the present invention;

FIG. 5 is a schematic diagram of oscillating of a temperature sensor around a set axis in the present invention; and

FIG. 6 is a schematic diagram of movement of a temperature sensor along a set path in the present invention.

### DETAILED DESCRIPTION

In conjunction with the accompanying drawings, the specific embodiments of the present invention are described below in detail.

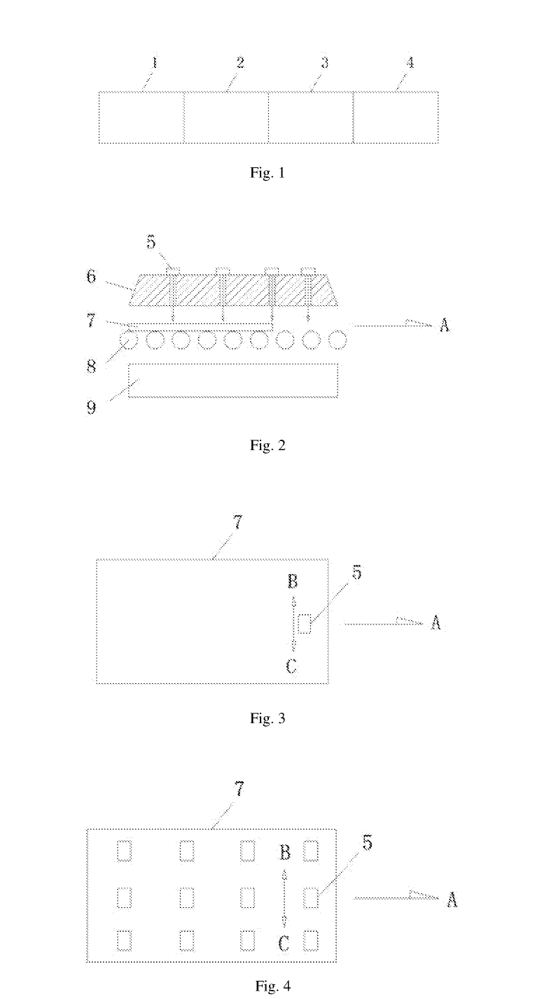

As shown in FIG. 2, a tempering and cooling system for tempered glass of the present invention is arranged in a quenching and cooling section of a tempered glass production line and specifically includes roller tables 8 for connecting a glass plate heating furnace 2 and an unloading table 4 (see FIG. 1), wherein a glass plate 7 is arranged on the roller tables 8, the glass plate 7 is sent to the unloading table 4 by the roller tables 8 along an arrow A in the figure, an upper wind grating 6 is arranged above the glass plate 7, a lower wind grating 9 is arranged below the glass plate 7, and the upper wind grating 6 and the lower wind grating 9 are in one-to-one correspondence. Temperature sensors 5 are arranged above the glass plate 7, the temperature sensors 5 are mounted at the top of the upper wind grating 6 and is used for collecting the temperature of the upper surface of the glass plate 7, and the temperature sensor 5 is preferably an infrared temperature measurement unit.

As shown in FIG. 3, the glass plate 7 moves along the A direction, one temperature sensor 5 is arranged above the glass plate 7, the temperature sensor 5 is used for collecting the temperature of the glass plate along the B-C direction, and the B-C direction is vertical to the motion direction A of the glass plate 7.

As shown in FIG. 4, the glass plate 7 moves along the A direction, a plurality of temperature sensors 5 are arranged above the glass plate 7, wherein 12 temperature sensors 5 are specifically equipped in the figure. The temperature sensors 5 are arranged in a matrix mode, and are used for collecting the temperature of the glass plate along the B-C direction which is vertical to the motion A direction of the glass plate 7.

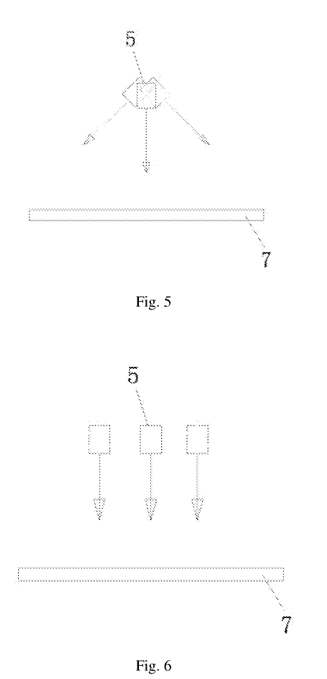

As shown in FIG. 5, the temperature sensor 5 is an oscillating-type temperature sensor, and the temperature sensor is used for scanning the surface of the glass plate by oscillating around a set axis during working to collect the surface temperature of the glass plate 7 in a glass plate region covered by a scanning range.

As shown in FIG. 6, the temperature sensor 5 may be mounted in the quenching and cooling section in a way of performing reciprocating movement parallel to the surface of the glass plate and is used for scanning the surface of the glass plate 7 by reciprocating movement during working to collect the surface temperature of the glass plate 7 in a glass plate region covered by a scanning range.

The temperature sensor 5 may be arranged above the glass plate 7 as shown in FIGS. 2-6, and of course, may also be arranged below the glass plate 7 (not shown); or the temperature sensors 5 are arranged above and below the glass plate 7 (not shown).

### Embodiment 1

By referring to FIGS. 1, 2, 4 and 5, a glass plate 7 sequentially passes through a loading table 1 and a heating furnace 2 and enters a quenching and cooling section 3, and then the glass plate 7 performs single-way motion towards an unloading table 4 on roller tables 8, namely moves along the A direction. In a tempering stage, an upper wind grating 6 and a lower wind grating 9 produce relatively large air pressure to rapidly cool and temper the glass plate 7, 12 temperature sensors 5 are distributed above the glass plate 7 in a matrix mode, each temperature sensor 5 is used for collecting the temperature of the upper surface of the glass plate 7 by continuous oscillating as shown in FIG. 5, after the temperature of the upper surface of the glass plate 7 is collected every time, the maximum value of the collected temperature is compared with the temperature of a tempering point required by the process, and if the temperature drops to the temperature of the tempering point, the glass plates enters a cooling stage; and after the glass plate enters the cooling stage, the air pressure in the tempering stage can be continuously kept, the air pressure can also be reduced, the temperature sensors 5 are continuously used for detecting the temperature of the upper surface of the glass plate 7, after the temperature of the upper surface of the glass plate 7 is collected every time, whether the cooling process is completed or not is judged according to the maximum value of the collected temperature, and if the temperature drops to the temperature of a cooling point, it means that the whole cooling process is completed, then the cooling is stopped and the glass plate 7 is sent to the unloading table 4 by the roller tables 8.

### Embodiment 2

Referring to FIGS. 1, 3 and 6, embodiment 2 is basically the same as embodiment 1, and the differences are as follows: in the whole cooling process, the glass plate 7 performs reciprocating motion on the roller tables 8, one temperature sensor 5 is equipped above the glass plate 7, and the temperature sensor 5 may be mounted in a quenching and cooling section in a way of performing reciprocating movement parallel to the surface of the glass plate, as shown in FIG. 6. In FIG. 6, specifically, the temperature sensor 5 can perform continuous reciprocating movement along the direction vertical to the traveling direction of the glass plate 7 to scan the surface of the glass plate, thereby collecting the surface temperature of the glass plate in a glass plate region covered by a scanning range.

### Embodiment 3

| | | | Set | | |
|---|---|---|---|---|---|
| | | | temperaure | | Set |
| | Thinkness | Tempering | of | Cooling air | temperature |
| Serial | of glass | air pressure | tempering | pressure | of cooling |
| number | plate (mm) | (Pa) | point (° C.) | (Pa) | point (° C.) |
| Sample 1 | 4 | 7500 | 380 | 2000 | 60 |
| Sample 2 | 5 | 3200 | 380 | 1500 | 60 |
| Sample 3 | 6 | 1800 | 380 | 1600 | 60 |
| Sample 4 | 8 | 750 | 380 | 1600 | 60 |
| Sample 5 | 10 | 600 | 380 | 1600 | 60 |
| Sample 6 | 12 | 400 | 380 | 1500 | 60 |
| Sample 7 | 15 | 200 | 380 | 1500 | 60 |
| Sample 8 | 19 | 200 | 380 | 1500 | 60 |

In the embodiment, the glass plates with 8 different thicknesses are respectively tempered by tempering air pressures with 8 different strengths in the tempering stage, and when the temperature sensor detects that the temperature of the upper surface of each glass plate achieves the temperature of the tempering point, i.e. 380° C., the glass plates enter the cooling stage; and in the cooling stage, the glass plates are cooled by cooling air pressures with different strengths, and when the temperature sensor detects that the temperature of the upper surface of each glass plate drops to the temperature of the cooling point, i.e. 60° C., the cooling is stopped, and the glass plates are sent to the unloading table.

The above examples are only used for describing the present invention, and the embodiments of the present invention are not limited to these examples. Various specific embodiments which are made by those skilled in the art and are in line with the thinking of the present invention are within the scope of protection of the present invention.

1. A tempering and cooling system for a glass plate, comprising:
a roller table to convey the glass plate from a heating furnace towards an unloading table;
a first wind grating to blow air to reduce a surface temperature of the glass plate; and
at least one temperature sensor, arranged above and/or below the glass plate, to detect the surface temperature of the glass plate and enable the tempering and cooling system to control a tempering process and/or a cooling process of the glass plate according to the detected surface temperature;
wherein the tempering and cooling system controls the tempering process and/or the cooling process of the glass plate by controlling a fan rotation speed of the first wind grating based on the detected surface temperature to:
produce a first wind pressure when the glass plate is in a tempering stage;
produce a second wind pressure upon the detected surface temperature dropping to a temperature of a tempering point such that the glass plate enters a cooling stage; and
produce a third wind pressure lower than the second wind pressure upon the detected surface temperature dropping to a temperature of a cooling point.

2. The tempering and cooling system according to claim 1, wherein more than one temperature sensors are equipped above and/or below the glass plate; and the tempering and cooling system determines a time when the tempering stage is ended and a time when the cooling stage of the glass plate is ended according to a maximum value of temperatures detected by the more than one temperature sensors every time.

3. The tempering and cooling system according to claim 1, wherein the at least one temperature sensor is a swing-type temperature sensor, and the at least one temperature sensor is used for scanning the surface of the glass plate by swinging during working to detect the surface temperature of the glass plate in a glass plate region covered by a scanning range.

4. The tempering and cooling system according to claim 1, wherein the at least one temperature sensor reciprocates in parallel to a surface of the glass plate and scan the surface of the glass plate by a reciprocating movement during working to detect the surface temperature of the glass plate in a glass plate region covered by a scanning range.

5. The tempering and cooling system according to claim 1, wherein the at least one temperature sensor is mounted on the first wind grating.

6. The tempering and cooling system according to claim 1, wherein the at least one temperature sensor is an infrared temperature measurement unit.

7. The tempering and cooling system according to claim 1, comprising:
a second wind grating, corresponding to the first wind grating, to blow air to reduce the surface temperature of the glass plate;
wherein:
the tempering and cooling system controls the tempering process and/or the cooling process of the glass plate by controlling a respective fan rotation speed of the first and second wind gratings based on the detected surface temperature.

8. The tempering and cooling system according to claim 1, wherein the third wind pressure is zero or near zero.

9. The tempering and cooling system according to claim 1, wherein the tempering and cooling system controls the tempering process and/or the cooling process of the glass plate by controlling the first wind pressure and the second wind pressure based on a thickness of the glass plate.

10. The tempering and cooling system according to claim 1, wherein upon the detected surface temperature dropping to a temperature of a cooling point, the tempering and cooling system stops the cooling process and controls the roller table to convey the glass plate to the unloading table.

11. The tempering and cooling system according to claim 1, wherein:
the tempering and cooling system controls the fan rotation speed of the first wind grating to produce the first wind pressure based on a thickness of the glass plate when the glass plate is in the tempering stage.
